(19) United States
(12) Patent Application Publication
(10) Pub. No.: US 2016/0360219 A1
(43) Pub. Date: Dec. 8, 2016

(54) PREVENTING I-FRAME POPPING IN VIDEO ENCODING AND DECODING

(71) Applicant: Apple Inc., Cupertino, CA (US)

(72) Inventors: Feng Yi, San Jose, CA (US); Yeping Su, Sunnyvale, CA (US); Chris Y. Chung, Sunnyvale, CA (US); Hsi-Jung Wu, San Jose, CA (US); Xiaosong Zhou, Campbell, CA (US)

(21) Appl. No.: 14/732,615

(22) Filed: Jun. 5, 2015

(51) Int. Cl. H04N 19/50; H04N 19/61

(52) U.S. Cl. CPC H04N 19/50; H04N 19/61

(57) ABSTRACT

Methods and systems provide video compression to reduce a “popping” effect caused by differences in quality between a refresh frame (e.g., I-frame or IDR-frame) and neighboring frame(s). In an embodiment, a quality of a pre-definable number of frames preceding a refresh frame (“preceding frames”) may be increased. A quantization parameter may be decreased for a region within at least one of the preceding frame(s). In an embodiment, preceding frames may be coded according to an open group of pictures (“GOP”) structure. In an embodiment, a refresh frame may be first coded as a P-frame, then coded based on the coded P-frame. In an embodiment, preceding frames may be first coded based on the refresh frame, then coded based on the coded frames without referencing the refresh frame. Each of these methods may increase consistency of quality in a sequence of frames, and, correspondingly, minimize or remove I-frame popping.

### BACKGROUND

The present disclosure relates to a method of minimizing artifacts in video coding and compression. More specifically, it relates to methods for reducing a visual “popping” artifact that arises from inconsistent video coding quality.

Many video compression standards, e.g. H.264/AVC and H.265/HEVC (currently published as ISO/IEC 23008-2 MPEG-H Part 2 and ITU-T H.265), have been widely used in video capture, video storage, real time video communication and video transcoding. Examples of popular applications include Apple AirPlay® Mirroring, FaceTime®, and video capture in iPhone° and iPad®.

Most video compression standards achieve much of their compression efficiency by using some frames of compressed or decompressed video to define other frames. The frames that are used to define other frames are called “reference frames.” Examples of reference frames include refresh frames such as an Intra Frames (“I-frames”) and Instantaneous Decoder Refresh Frames (“IDR-frames”), Predictive Frames (“P frames”) that usually reference one previously coded reference frame, and Bidirectionally Predictive Frames (“B frames”) that usually reference one or two previously coded reference frames. Reference frames are typically encoded to be of higher quality compared with other types of frames because other frames referring to the reference frame may benefit from coding with reference to a higher quality frame

However, when neighboring frames are of disparate quality, there may be a distracting visual effect known as “key frame popping,” “I-frame popping,” “flashing,” “beating,” or simply “popping.” An image or video stream may appear to degrade, then suddenly “pop” back into higher quality. For example, a new group of pictures (“GOP”) may begin with an I-frame. Supposing that the I-frame is of higher quality compared with the other constituent frames of the GOP, the beginning of each GOP may appear as a “sudden” increase in quality due to the I-frame boost in quality.

This “popping” effect may be minimized by adaptively positioning the I-frames, for example at a scene change instead of in the middle of a scene. When an I-frame is placed at a scene change, the popping will not be visible. However, there is usually a maximum I-frame distance, and in long scenes, an encoder may be forced to place an I-frame before the scene change. Furthermore, coding efficiency may be reduced by requiring I-frames to be placed only at a scene change.

The inventors perceived a need in the art to minimize or remove a popping effect due quality variations across frames, including for a sequence of frames having a key frame that is not placed at a scene change. Popping may be particularly noticeable near refresh frames such as IDR-frames, in an area of relatively low complexity, and/or where bandwidth is limited.

### BRIEF DESCRIPTION OF THE DRAWINGS

FIG. 1 is a block diagram of a multi-terminal system implementing the methods and systems described herein.

FIG. 2 is a block diagram of a coding and decoding system implementing the methods and systems described herein.

FIG. 3 is a simplified block diagram of a coding system implementing the methods and systems described herein.

FIG. 4 a flowchart illustrating a method for video compression according to an embodiment of the present disclosure.

FIG. 5A is a flowchart illustrating a method for video compression using open GOP according to an embodiment of the present disclosure.

FIG. 5B is a conceptual diagram of using open GOP for video compression according to an embodiment of the present disclosure.

FIG. 6A is a flowchart illustrating another method for video compression according to an embodiment of the present disclosure.

FIG. 6B is a conceptual diagram of a media stream according to an embodiment of the present disclosure.

FIG. 7A is a flowchart illustrating another method for video compression according to an embodiment of the present disclosure.

FIG. 7B is a conceptual diagram of a media stream according to an embodiment of the present disclosure.

### DETAILED DESCRIPTION

Methods and systems provide techniques for minimizing or removal of a popping artifact from a sequence of frames of video data. In an embodiment, a method may include determining for a given frame whether a popping effect is likely to occur from a default coding mode. If the method determines that a popping effect is likely, the method may assign an alternate coding mode to image content in a region of the given frame. Otherwise, the method may assign the default coding mode to image content in the region. Thereafter, the method may code image content of the region according to the assigned mode.

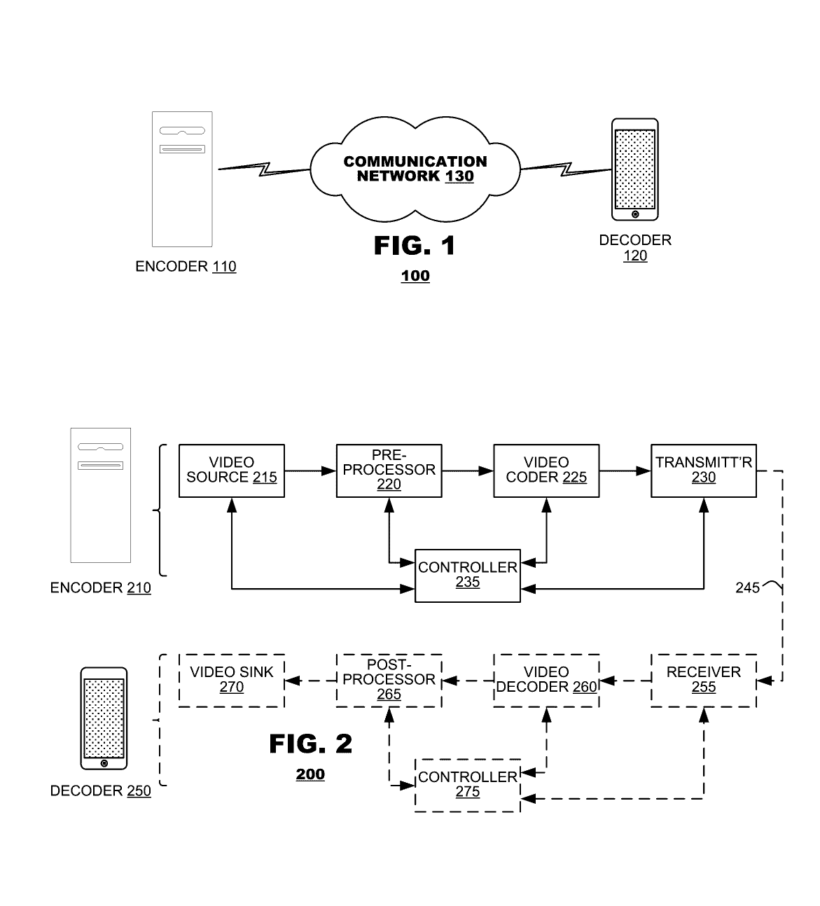

FIG. 1 illustrates a simplified block diagram of a video coding system 100 according to an embodiment of the present disclosure. The system 100 may include at least two terminals 110-120 interconnected via a network 130. As shown, in an embodiment, the terminal 110 may be an encoder and the terminal 120 may be a decoder. For unidirectional transmission of data, a first terminal 110 may code video data at a local location for transmission to the other terminal 120 via the network 130. The second terminal 120 may receive the coded video data of the other terminal from the network 130, decode the coded data and display the recovered video data. Unidirectional data transmission is common in media serving applications and the like.

For bidirectional transmission of data, however, each terminal 110, 120 may code video data captured at a local location for transmission to the other terminal via the network 130. Each terminal 110, 120 also may receive the coded video data transmitted by the other terminal, may decode the coded data and may display the recovered video data at a local display device.

In FIG. 1, the terminals 110-120 are illustrated respectively as a server and a smart phone but the principles of the present disclosure are not so limited. Embodiments of the present disclosure find application with laptop computers, tablet computers, servers, media players and/or dedicated video conferencing equipment. Also, although terminal 110 is illustrated as an encoder and terminal 120 is illustrated as a decoder, each terminal may have both encoding and decoding capabilities. The network 130 represents any number of networks that convey coded video data among the terminals 110-120, including, for example, wireline and/or wireless communication networks. The communication network 130 may exchange data in circuit-switched and/or packet-switched channels. Representative networks include telecommunications networks, local area networks, wide area networks and/or the Internet. For the purposes of the present discussion, the architecture and topology of the network 130 is immaterial to the operation of the present disclosure unless explained herein below.

FIG. 2 is a functional block diagram of a video coding system 200 according to an embodiment of the present disclosure. In this example, only the components that are relevant to a unidirectional coding session are illustrated. The video coding system 200 may include a first terminal 210 that includes video source 215, a pre-processor 220, a video coder 225, a transmitter 230, and a controller 235. As shown, in an embodiment, the terminal 210 may be an encoder.

The video source 215 may provide video to be coded by the terminal 210. In a videoconferencing system, the video source 215 may be a camera that captures local image information as a video sequence or it may be a locally-executing application that generates video for transmission (such as in gaming or graphics authoring applications). In a media serving system, the video source 215 may be a storage device storing previously prepared video.

The pre-processor 220 may perform various analytical and signal conditioning operations on video data. For example, the pre-processor 220 may search for video content in the source video sequence that is likely to generate artifacts when the video sequence is coded, decoded, and displayed. The pre-processor 220 also may apply various filtering operations to the frame data to improve efficiency of coding operations applied by a video coder 225.

The video coder 225 may perform coding operations on the video sequence to reduce the bit rate of a sequence. The video coder 225 may code the input video data by exploiting temporal and spatial redundancies in the video data. The transmitter 230 may buffer coded video data and to prepare it for transmission to a second terminal 250. The controller 235 may manage operations of the first terminal 210.

The first terminal 210 may operate according to a coding policy, which may be implemented by the controller 235 and video coder 225. The controller 235 may select coding parameters to be applied by the video coder 225 in response to various operational constraints. Such constraints may be established by, among other things: a data rate that is available within the channel to carry coded video between terminals, a size and frame rate of the source video, a size and display resolution of a display at a terminal 250 that will decode the video, and error resiliency requirements required by a protocol by which the terminals operate. Based upon such constraints, the controller 235 and/or the video coder 225 may select a target bit rate for coded video (for example, as N bits/sec) and an acceptable coding error for the video sequence. Thereafter, they may make various coding decisions to individual frames of the video sequence. For example, the controller 235 and/or the video coder 225 may select a frame type for each frame, a coding mode to be applied to pixel blocks within each frame, and quantization parameters to be applied to frames and or pixel blocks.

During coding, the controller 235 and/or video coder 225 may assign to each frame a certain frame type, which can affect the coding techniques that are applied to the respective frame. Frames commonly are parsed spatially into a plurality of pixel blocks (for example, blocks of 4×4, 8×8, 16×16, 32×32, 64×64 pixels each) and coded on a pixel-block-by-pixel-block basis. Pixel blocks may be coded predictively with reference to other coded pixel blocks as determined by the coding assignment applied to the pixel blocks' respective frame. For example, pixel blocks of Intra Frames (“I-frames”) can be coded non-predictively or they may be coded predictively with reference to pixel blocks of the same frame (spatial prediction). Pixel blocks of Predictive Frames (“P frames”) may be coded non-predictively, via spatial prediction or via temporal prediction with reference to one previously coded reference frame. Pixel blocks of Bidirectionally Predictive Frames (“B frames”) may be coded non-predictively, via spatial prediction or via temporal prediction with reference to one or two previously coded reference frames. Video coder 225 includes its own decoder (not shown) that generates decoded video as it will be generated by a decoder 250. Some decoded frames will become reference frames.

FIG. 2 also illustrates components of an optional second terminal 250 that may receive and decode the coded video data. As illustrated, the second terminal 250 may be a decoder. The second terminal may include a receiver 255, a video decoder 260, a post-processor 265, a video sink 270; and a controller 275 to manage overall operation of the second terminal 250.

The receiver 255 may receive coded data from a channel 245 and parse it according to its constituent elements. For example, the receiver 255 may distinguish coded video data from coded audio data and route each coded data to decoders to handle them. In the case of coded video data, the receiver 255 may route it to the video decoder 260.

The video decoder 260 may perform decoding operations that invert processes applied by the video coder 225 of the first terminal 210. Thus, the video decoder 260 may perform prediction operations according to the coding mode that was identified and perform entropy decoding, inverse quantization and inverse transforms to generate recovered video data representing each coded frame.

Post-processor 265 may perform additional processing operations on recovered video data to improve quality of the video prior to rendering. Filtering operations may include, for example, filtering at pixel block edges, anti-banding filtering and the like.

Video sink 270 may consume the reconstructed video. The video sink 270 may be a display device that displays the reconstructed video to an operator. Alternatively, the video sink may be an application executing on the second terminal 250 that consumes the video (as in a gaming application).

FIG. 2 illustrates only the components that are relevant to unidirectional exchange of coded video. As discussed, the principles of the present disclosure also may apply to bidirectional exchange of video. In such an embodiment, the elements 215-235 illustrated for capture and coding of video at the first terminal 210 may be replicated at the second terminal 250. Similarly the elements 255-275 illustrated for decoding and rendering of video at the second terminal 250 may be replicated at the first terminal 210. Indeed, it is permissible for terminals 210, 250 to have multiple instantiations of these elements to support exchange of coded video with multiple terminals simultaneously, if desired.

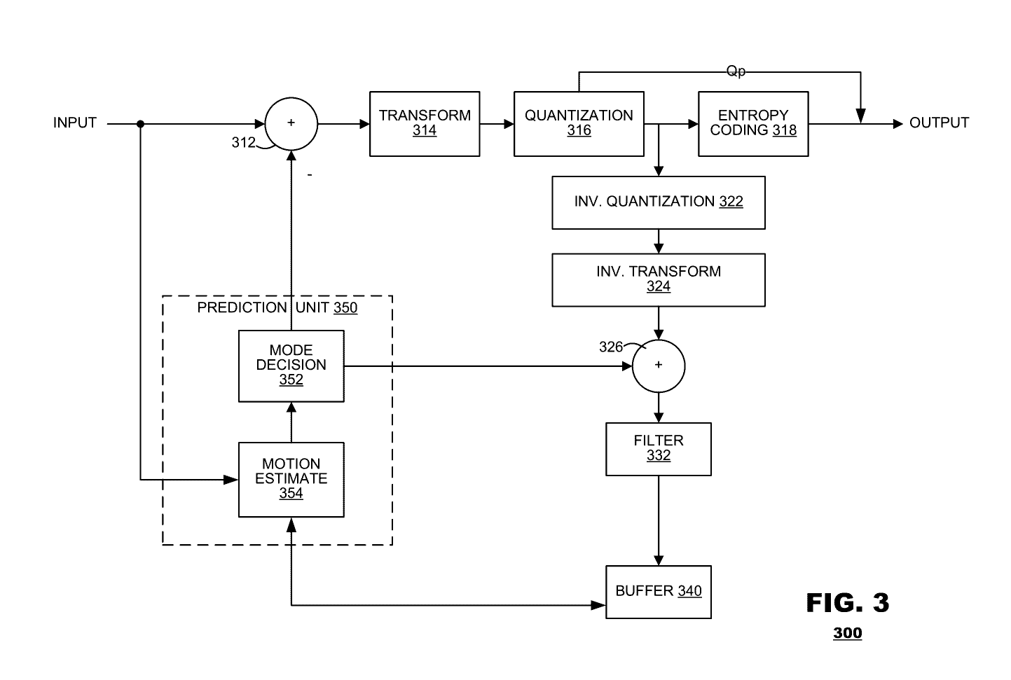

FIG. 3 illustrates a video coder 300 according to an embodiment of the present disclosure. The coder 300 may include a subtractor 312, a transform unit 314, a quantizer 316 and an entropy coding unit 318. The subtractor 312 may receive an input motion compensation block from a source image and, depending on a prediction mode used, a predicted motion compensation block from a prediction unit 350. The subtractor 312 may subtract the predicted block from the input block and generate a block of pixel residuals. If no prediction is performed, the subtractor 312 simply may output the input block without modification. The transform unit 314 may convert the block it receives to an array of transform coefficients according to a spatial transform, typically a discrete cosine transform (“DCT”) or a wavelet transform. The quantizer 316 may truncate transform coefficients of each block according to a quantization parameter (“QP”). The QP values used for truncation may be transmitted to a decoder in a channel. The entropy coding unit 318 may code the quantized coefficients according to an entropy coding algorithm, for example, a variable length coding algorithm or context-adaptive binary arithmetic coding. Additional metadata containing the message, flag, and/or other information discussed above may be added to or included in the coded data, which may be output by the system 300.

The system 300 also may include an inverse quantization unit 322, an inverse transform unit 324, an adder 326, a filter system 332, a buffer 340, and a prediction unit 350. The inverse quantization unit 322 may quantize coded video data according to the QP used by the quantizer 316. The inverse transform unit 324 may transform re-quantized coefficients to the pixel domain. The adder 326 may add pixel residuals output from the inverse transform unit 324 with predicted motion data from the prediction unit 350. The summed output from the adder 326 may output to the filtering system 332. The filtering system 332 also may various types of filters such as deblocking and sample adaptive offset, but these are not illustrated in FIG. 3 merely to simplify presentation of the present embodiments of the disclosure. Filters in the filtering system 332 may be applied to reconstructed samples before they are written into a decoded picture buffer 340 in a decoder loop.

The buffer 340 may store recovered frame data as outputted by the filtering system 332. The recovered frame data may be stored for use as reference frames during coding of later-received blocks.

The prediction unit 350 may include a mode decision unit 352, and a motion estimator 354. The motion estimator 354 may estimate image motion between a source image being coded and reference frame(s) stored in the buffer 340. The mode decision unit 352 may assign a prediction mode to code the input block and select a block from the buffer 340 to serve as a prediction reference for the input block. For example, it may select a prediction mode to be used (for example, uni-predictive P-coding or bi-predictive B-coding), and generate motion vectors for use in such predictive coding. In this regard, prediction unit 350 may retrieve buffered block data of selected reference frames from the buffer 340.

As discussed, a “popping” effect may be caused by a quality difference between a refresh frame (such as an I-frame or an IDR-frame) and a neighboring frame of another type. The popping effect may be minimized or reduced by reducing a difference in quality between neighboring frames.

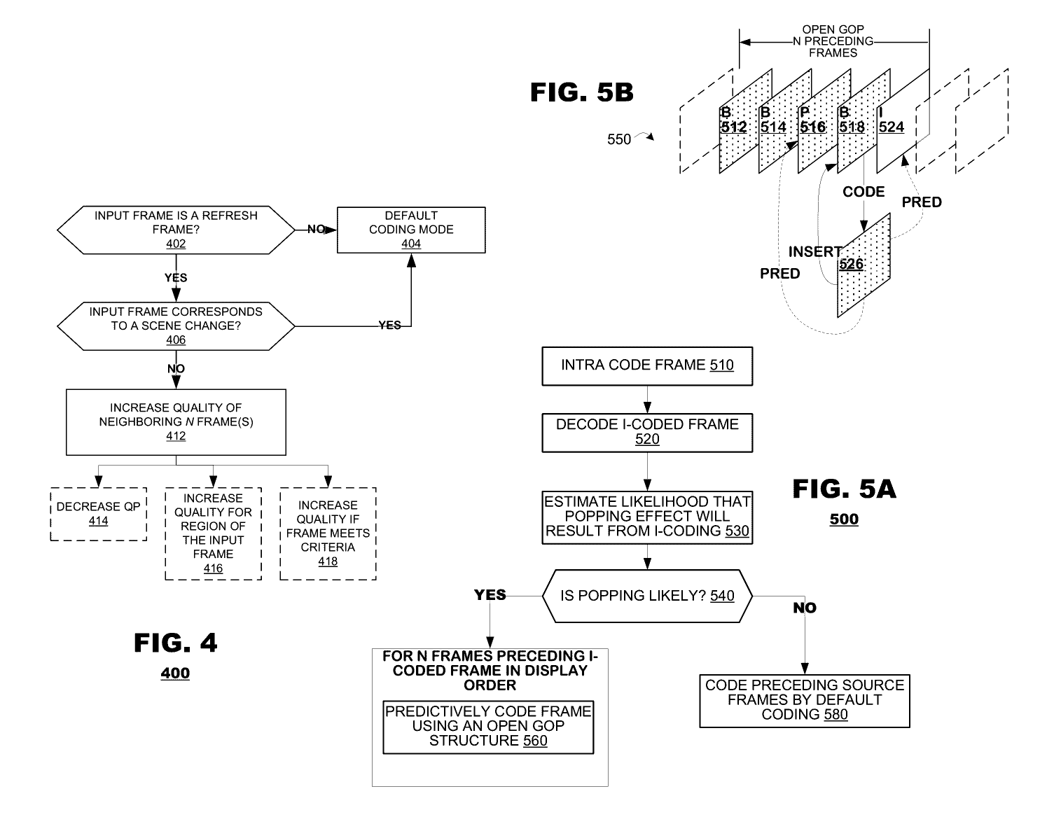

FIG. 4 a flowchart illustrating a method 400 for video compression according to an embodiment of the present disclosure. The method 400 may increase a quality of one or more frames preceding a refresh frame. The method 400 may be performed by any of the systems described herein. In an embodiment, the method 400 may be performed by the coder 300 shown in FIG. 3.

The method 400 may determine whether popping is likely. For example, popping may be likely if an input frame is an I frame and the input frame does not correspond to a scene change. In an embodiment, the method 400 may determine whether an input frame is a refresh frame such as an I-frame or an IDR-frame (box 402). If the input frame is not a refresh frame, the method may proceed to code the frame according to a default or standard coding method (box 404). Otherwise, the method 400 may determine whether the input frame corresponds to a scene change (box 406). If the input frame corresponds to a scene change, the method 400 may proceed to code the frame according to a default or standard coding method (box 404).

If the method 400 determines that the input frame does not correspond to a scene change (box 406), the method 400 may increase the quality of one or more frames preceding the input frame (box 412). An input frame not corresponding to a scene change may indicate that popping is likely. For example, the quality of a frame may be increased by lowering the QP for the frame (box 414). The number of preceding frames for which quality is increased may be a pre-determined number, e.g., N frames. By way of non-limiting example, a range may be 24 frames for a 24 frames per second movie. In another embodiment, a preceding number of frames for which quality is increased may be measured in terms of time. For example, QP may be lowered for a number of frames falling within a tunable time range or before a pre-determined end time.

Embodiments of the present disclosure may conserve computational resources and memory by increasing quality for a region of a frame such as pixel blocks within a frame (box 416). In an embodiment, the quality of the entire frame is increased. In an alternative embodiment, the quality of a portion of a frame is increased, rather than for the entire frame. For example, a region of relatively low complexity may be coded with increased quality. This is because the region of relatively low complexity is relatively static. Thus, popping is more noticeable in these regions compared with areas of greater motion and/or greater complexity.

Whether a region of a frame is considered to be of “relatively low complexity” may be determined based on a comparison of the region's complexity to a difference threshold. The difference threshold may be pre-defined. By increasing quality for a region of a frame rather than an entire frame, coding may be more efficient because fewer bits are consumed for coding.

In an embodiment, the method 400 may increase a quality of a particular frame rather than all frames (box 418). For instance, QP may be lowered for a frame if the frame is a B-frame or a P-frame. In another embodiment, the method 400 may increase a quality for select references frames. For instance, every Mth reference frame may be encoded with increased quality. This may save the number of bits consumed for coding by reducing the number of frames coded with increased quality.

The evaluation of boxes 402 and 406 may represent a determination of a likelihood of popping effect or a noticeability of a popping effect. For example, likelihood of popping may be increased near a refresh frame. Likelihood of popping may be increased if a refresh frame corresponds to a scene change. Also, the likelihood of popping being noticeable may be increased if a quality between neighboring frames exceeds a quality threshold. As discussed herein, where one frame has a jump in quality compared with a neighboring frame, the frame with higher quality may appear to “pop” in the sequence of frame.

FIG. 5A shows a method 500 according to an embodiment of the present disclosure. When a frame is designated to be an intra-coded frame, the frame may be coded according to intra coding (box 510), then decoded (box 520). The method 500 may estimate a likelihood that a popping effect will occur from intra coding (boxes 530, 540). If popping is estimated to be likely, the method 500 may code a sub-sequence of frames that precede the I-coded frame according to an alternate coding protocol than would occur by default. Specifically, the method 500 may code frames from the sub-sequence according to predictive coding techniques, using the decoded I frame as a reference frame (box 560) where the I frame may be part of a neighboring GOP.

Of course, if the method 500 determined that popping was not likely, then the frames that otherwise would be members of the sub-sequence may be coded according to default coding techniques (box 580).

FIG. 5B illustrates an exemplary video sequence 560 having an open GOP structure that may be coded according to the method 500 of FIG. 5A. By using an open GOP structure, frames prior to the refresh frame may reference the refresh frame, which may result in a smoother quality change between neighboring frames. Unlike a closed GOP, an open GOP allows the B-frames from one GOP to refer to an I- or P-frame in an adjacent GOP.

There, a frame 524 is designated to be an I frame. It may be coded, then decoded to generate a decoded frame 526. If the method 500 determines that a popping effect likely will occur from coding frame 524, then it may process a predetermined number of frames (frames 512-518 in the example of FIG. 5B) according to the operations of box 560. For example, frame 518 is illustrated as being coded predictively with reference to the decoded I frame 526. The coding operations (box 750) may be repeated for the other frames 512-518 in the sub-sequence. Thus, in the example shown in FIG. 5A, B-frame 518 references I-frame 524, which belongs to an adjacent GOP, and P-frame 516. Any popping effect due to a jump in quality of the I-frame 524 may be minimized or removed because the N preceding frames reference the I-frame 524. By referencing the I-frame 524, differences between the N preceding frames and the I-frame 524 may be reduced, resulting in a reduced change in quality between the two frames. For simplicity, reference relationships for the unlabeled frames are not shown in FIG. 5A. For example, each of the B-frames 512, 514, 516, and 518 may reference prior frames or subsequent frames such as the frame 524.

As discussed, a “popping” effect may be caused by a quality difference between a refresh frame (such as an I-frame or an IDR-frame) and a neighboring frame of another type. The popping effect may be minimized or reduced by reducing a difference in quality between neighboring frames. In an embodiment of the present disclosure, a refresh frame may be re-encoded to reduce a quality difference between the refresh frame and neighboring frames. In another embodiment of the present disclosure, one or more frames preceding a refresh frame may be re-encoded using the refresh frame to reduce a quality difference between the preceding frames and the refresh frame. This may minimize or eliminate a popping effect in a sequence of video frames.

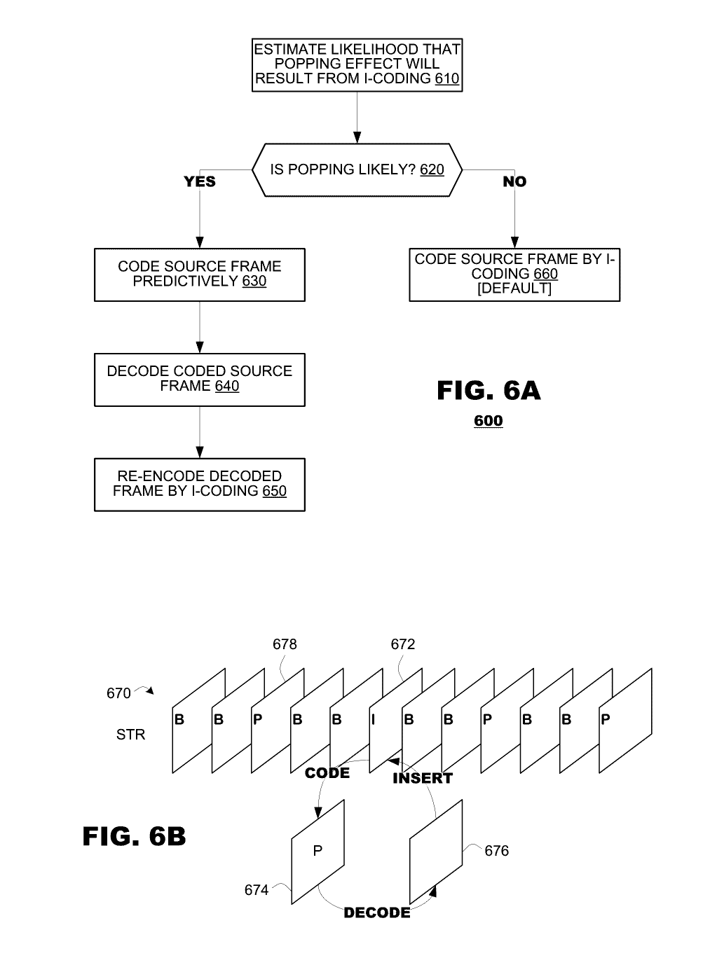

FIG. 6A shows a method 600 according to an embodiment of the present disclosure. When a frame is assigned for intra coding, the method 600 may estimate a likelihood that a popping effect will occur from intra coding (boxes 610, 620). If popping is estimated to be likely, the method 600 may code the source frame according to predictive coding techniques (box 630) then decode the predictively-coded frame (box 640). Thereafter, the method may code the decoded source frame according to the frame's intra coding assignment (box 650).

As shown, in an embodiment, the method 600 may be applied if key frame popping is likely (box 620). Otherwise, if key frame popping is unlikely, a default coding mode may be applied (box 660). Whether key frame popping is likely to occur may be based on a degree of difference between a key frame and neighboring frames as discussed herein.

Predictive coding (box 630), then decoding (box 640) of the source frame is expected to reduce popping artifacts that otherwise might arise in a coded video sequence. Video coding is a lossy process, which can arise from quantization of transform coefficients and losses incurred over multi-frame prediction chains. As discussed, when a given source frame is I-coded, distortions that appear in the I-coded frame may be perceived as abrupt transitions in coding quality as compared to the frames that precede the I-coded frame in display order. By coding the source frame predictively, decoding that frame, and recoding it by I-coding, it is expected that some continuity in coding quality will be preserved into the I-coded frame.

In an embodiment, the predictive coding of the source frame may use a lower QP than otherwise might in other predictively-coded frames in a video sequence. When a source frame is subject to two stages of coding in boxes 630 and 650, it will be subject to two stages of quantization. Lowering the QP of the predictive coding may be appropriate to maintain continuity of coding quality in the overall sequence.

FIG. 6B illustrates an exemplary sequence of video that may be coded according to the method 600 of FIG. 6A. There, frames of a video sequence 670 are annotated with coding assignments. In this example, the coding assignments are applied in the familiar IBBPBBPBPP pattern, and a source frame 672 is shown as assigned an I-coding mode. If it is estimated that I-coding of the frame 672 is likely to generate a popping artifact, the frame may be coded predictively, represented by coded frame 674, and it may be decoded to generate a decoded frame 676. The decoded frame 676 may be coded by I-coding, which is analogous to substituting the decoded frame 676 for the source frame 672 in the source video sequence 670.

The predictive coding may use a previously-coded reference frame as a source of prediction. Thus, coded frame 674 may be coded predictively with reference to a reference frame (say, P frame 678). When the decoded frame 676 is coded by I-coding, however, it may be coded without temporal prediction. Thus, I coded frame 676 appears in the coded video sequence as an I-frame for all purposes.

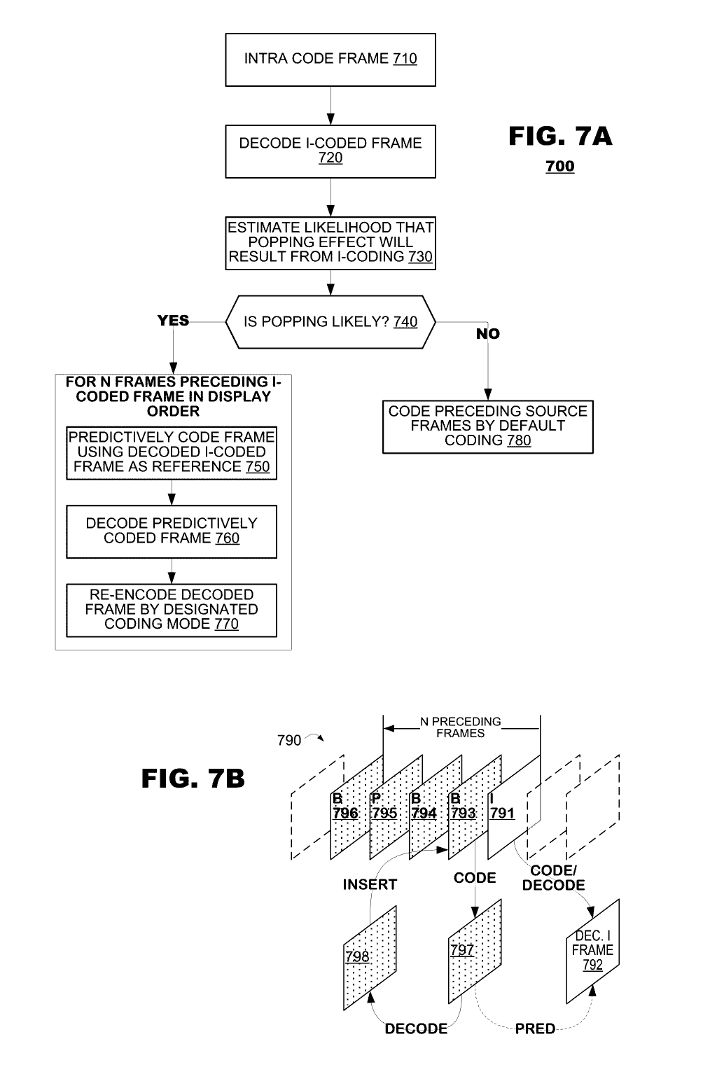

FIG. 7A shows a method 700 according to another embodiment of the present disclosure. When a frame is designated to be an intra-coded frame, the frame may be coded according to intra coding (box 710), then decoded (box 720). The method 700 may estimate a likelihood that a popping effect will occur from intra coding (boxes 730, 740). If popping is estimated to be likely, the method 700 may code a sub-sequence of frames that precede the I-coded frame according to an alternate coding protocol than would occur by default. Specifically, the method 700 may code frames from the sub-sequence according to predictive coding techniques, using the decoded I frame as a reference frame (box 750). The method 700 thereafter may decode the predictively coded frames from the sub-sequence (box 760), then predictively code them by its designated coding mode (box 770).

Of course, if the method 700 determined that popping was not likely, then the frames that otherwise would be members of the sub-sequence may be coded according to default coding techniques (box 780).

FIG. 7B illustrates an exemplary video sequence 790 that may be coded according to the method 700 of FIG. 7A. There, a frame 791 is designated to be an I frame. It may be coded, then decoded to generate a decoded frame 792. If the method 700 determines that a popping effect likely will occur from coding frame 791, then it may process a predetermined number of frames (frames 793-796 in the example of FIG. 7B) according to the operations of boxes 750-770. For example, frame 793 is illustrated as being coded predictively with reference to the decoded I frame 792, shown as coded frame 797, then decoded as frame 798. Then the decoded frame 798 is coded according to its designated mode. Doing so is analogous to inserting the decoded frame 798 into the source sequence 790 as a substitute for source frame 793.

The coding and decoding operations (boxes 750, 760) may be repeated for the other frames 794-796 in the sub-sequence.

At box 770, the various substitute frames in the sub-sequence may be coded according to their designated coding mode. In the example of FIG. 7B, the substitute frames for frames 793, 794, and 796 may be coded according to B coding and the substitute frame for frame 795 may be coded according to P coding.

In an embodiment, the method 600 and the method 700 may each be applied locally, i.e. to a portion of a frame rather than an entire frame. For example, the re-encoding steps may be performed for those pixel blocks of a frame that is of relatively low complexity (or relatively static between frames). This way, a number of bits using for coding may be reduced compared with coding using an entire frame, while minimizing popping.

Whether a region of a frame is considered to be of “relatively low complexity” may be determined based on a comparison of the region's complexity to a difference threshold. The difference threshold may be pre-defined. By increasing quality for a region of a frame rather than an entire frame, coding may be more efficient because fewer bits are consumed for coding.

The concepts have been described for in-loop processing, i.e. processing steps performed before writing reconstructed samples into a buffer. The concepts also apply to post-processing, i.e. processing steps performed on reconstructed samples. For instance, a temporal smoothing filter may be applied selectively on a transition around a non-scene change IDR-frame in a post-processing procedure.

In embodiments, a “popping” effect may be minimized or removed as part of a decoding process. In an embodiment, a scene change may be detected on a decoder side, thus triggering inverse processes to those described herein. In an embodiment, a type of encoding performed may be conveyed by an encoder as metadata to instruct a decoder to decode the data accordingly. For instance, when the methods described herein are performed by an encoder, information about the method used may be transmitted to the decoder to instruct the decoder to decode the data appropriately.

The concepts described here are for situations in which a refresh frame is of higher quality than other types of frames. “Popping” may also result where a refresh frame is of lower quality than neighboring frames. The concepts described here regarding the processing of non-refresh frames to be of more similar quality to the refresh frame and processing of a refresh frame to be of more similar quality to neighboring non-refresh frames also apply in the situation in which a refresh frame is of lower quality than neighboring non-refresh frames.

Although the foregoing description includes several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

As used in the appended claims, the term “computer-readable medium” may include a single medium or multiple media, such as a centralized or distributed database, and/or associated caches and servers that store one or more sets of instructions. The term shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

The present specification describes components and functions that may be implemented in particular embodiments which may operate in accordance with one or more particular standards and protocols. However, the disclosure is not limited to such standards and protocols. Such standards periodically may be superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

For example, operation of the disclosed embodiments has been described in the context of servers and terminals that implement video compression, coding, and decoding. These systems can be embodied in electronic devices or integrated circuits, such as application specific integrated circuits, field programmable gate arrays and/or digital signal processors. Alternatively, they can be embodied in computer programs that execute on personal computers, notebook computers, tablets, smartphones or computer servers. Such computer programs typically are stored in physical storage media such as electronic-, magnetic- and/or optically-based storage devices, where they may be read to a processor, under control of an operating system and executed. And, of course, these components may be provided as hybrid systems that distribute functionality across dedicated hardware components and programmed general-purpose processors, as desired.

In addition, in the foregoing Detailed Description, various features may be grouped or described together the purpose of streamlining the disclosure. This disclosure is not to be interpreted as reflecting an intention that all such features are required to provide an operable embodiment, nor that the claimed embodiments require more features than are expressly recited in each claim. Rather, as the following claims reflect, subject matter may be directed to less than all of the features of any of the disclosed embodiments. Thus, the following claims are incorporated into the Detailed Description, with each claim standing on its own as defining separately claimed subject matter.

Also, where certain claims recite methods, sequence of recitation of a particular method in a claim does not require that that sequence is essential to an operable claim. Rather, particular method elements or steps could be executed in different orders without departing from the scope or spirit of the invention.

What is claimed is:

1. A method, comprising:
when a first frame is to be coded as an I frame, estimating a difference that will arise between the first frame, when it is decoded, and decoded frames that precede the first frame in display order; and
when the difference meets a predetermined triggering condition:
coding the frames in a manner that creates a prediction chain between the first frame and at least one other frame,
decoding the coded frames, and
recoding the decoded frames in a manner that does not create a prediction chain between the first frame and the at least one other frame.

2. The method of claim 1, wherein:
the coding includes coding the first frame using the at least one other frame as a prediction reference,
the decoding includes decoding the coded first frame, and
the recoding includes recoding the decoded first frame according to intra coding.

3. The method of claim 1, wherein:
the coding includes coding the at least one other frame using the first frame as a prediction reference,
the decoding includes decoding the coded at least one other frame, and
the recoding includes recoding the decoded at least one other frame using an earlier frame as a prediction reference.

4. The method of claim 1, further comprising repeating the coding, the decoding and the recoding for a plurality of frames that precede the first frame in display order.

5. The method of claim 1, wherein the estimation comprises estimating a change in brightness between content of the first frame and the preceding frames.

6. The method of claim 1, wherein the estimation comprises estimating a change in energy of AC transform coefficients between content of the first frame and the preceding frames.

7. The method of claim 1, wherein the estimation comprises detecting whether a scene change occurs at the first frame.

8. The method of claim 1, wherein the estimation, the coding, the decoding, and the recoding are performed on sub-regions of the frames.

9. The method of claim 8, wherein the recoding includes decreasing a quantization parameter for a region of low complexity within the frames.

10. The method of claim 9, wherein the region in the frames is determined to have low complexity if a difference between the region in one frame and a corresponding region in a second frame is below a difference threshold.

11. The method of claim 1, wherein the recoding uses a lower quantization parameter compared with the coding.

12. The method of claim 1, wherein the estimation is performed if the first frame to be coded is an Instantaneous Decoder Refresh frame.

13. The method of claim 1, wherein the predetermined triggering condition is based on a difference in quality between the first frame and the decoded frames that precede the first frame in display order.

14. The method of claim 1, wherein the coding, decoding, and recoding decreases a difference in quality between the first frame and the preceding frames.

15. A method, comprising:
when a first frame is to be coded as an I frame, estimating a difference that will arise between the first frame, when it is decoded, and decoded frames that precede the first frame in display order; and
when the difference meets a predetermined triggering condition:
coding a plurality of frames preceding the first frame in display order according to an open group of pictures (GOP) structure such that at least one of the plurality of preceding frames is in a first GOP and references the first frame, wherein the first frame is outside the first GOP.

16. The method of claim 16, wherein the plurality of frames preceding the first frame includes a pre-defined number of frames preceding the first frame.

17. The method of claim 16, wherein the estimation includes at least one of:
estimating a change in brightness between content of the first frame and the preceding frames;
estimating a change in energy of AC transform coefficients between content of the first frame and the preceding frames; and
detecting whether a scene change occurs at the first frame.

18. A video coding system comprising:
a reference picture cache storing a plurality of frames of a video sequence to be coded;
a coder configured to:
when a first frame is to be coded as an I frame, estimate a difference that will arise between the first frame, when it is decoded, and decoded frames that precede the first frame in display order; and
when the difference meets a predetermined triggering condition:
code the frames in a manner that creates a prediction chain between the first frame and at least one other frame,
decode the coded frames, and
recode the decoded frames in a manner that does not create a prediction chain between the first frame and the at least one other frame.

19. The method of claim 18, wherein the estimation includes at least one of:
estimating a change in brightness between content of the first frame and the preceding frames;
estimating a change in energy of AC transform coefficients between content of the first frame and the preceding frames; and
detecting whether a scene change occurs at the first frame.

20. A non-transitory computer-readable medium storing program instructions that, when executed, cause a processor to perform a method, the method comprising:
when a first frame is to be coded as an I frame, estimating a difference that will arise between the first frame, when it is decoded, and decoded frames that precede the first frame in display order; and
when the difference meets a predetermined triggering condition:
coding the frames in a manner that creates a prediction chain between the first frame and at least one other frame,
decoding the coded frames, and
recoding the decoded frames in a manner that does not create a prediction chain between the first frame and the at least one other frame.
